(19) United States
(12) Patent Application Publication
(10) Pub. No.: US 2025/0337034 A1
(43) Pub. Date: Oct. 30, 2025

(54) METHOD FOR ADJUSTING THE TRANSITION METAL COMPOSITION OF A LITHIUM TRANSITION METAL OXIDE MATERIAL

(71) Applicant: UCHICAGO ARGONNE, LLC, Chicago, IL (US)

(72) Inventors: Eva ALLEN, Berwyn, IL (US); Jessica DURHAM MACHOLZ, Braidwood, IL (US); Albert L. LIPSON, Oak Park, IL (US)

(21) Appl. No.: 18/647,334

(22) Filed: Apr. 26, 2024

(51) Int. Cl. H01M 10/54; C01G 53/00

(52) U.S. Cl. CPC H01M 10/54; C01G 53/50; C01P 2002/72; C01P 2004/03; C01P 2004/51; C01P 2006/40

(57) ABSTRACT

A method for adjusting the transition metal composition of a lithium transition metal oxide cathode active material, such as a lithium nickel manganese cobalt oxide material, comprises precipitating a transition metal hydroxide onto the surface of particles of a first lithium transition metal oxide to form coated particles; isolating the coated particles; combining the isolated coated particles with an amount of lithium hydroxide; and calcining the resulting mixture at a temperature in the range of about 700 to about 950° C. (e.g., 800 to 900° C.) to form a second lithium transition metal oxide that has a different transition metal composition than the first lithium transition metal oxide material; wherein the amount of lithium hydroxide is selected to afford a target ratio of lithium to transition metals in the second lithium transition metal oxide after calcining.

### STATEMENT OF GOVERNMENT INTEREST

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to lithium batteries. More particularly, this invention relates to methods for adjusting the transition metal content of lithium metal oxide cathode materials, such as those recovered from waste lithium batteries and waste cathode components thereof.

### BACKGROUND OF THE INVENTION

Lithium (nickel manganese cobalt) oxide (NMC) materials are currently widely used as cathode active materials in lithium batteries in a number of energy storage applications. NMC cathode materials that currently are being directly recovered from electric and hybrid vehicle batteries are typically about 15 years old and are likely to be of lower nickel content than is used in current batteries. NMC cathode materials with lower nickel content produce capacities that are too low for modern applications of energy storage. A number of processes have been investigated for increasing nickel content of recycled NMC materials (often referred to as “upcycling”), including ionothermal methods using expensive ionic liquids, hydrothermal methods requiring high pressure reactors, and solid-state methods which suffer from non-uniform composition and poor penetration of nickel rich phases. There are ongoing needs for new, reliable, and/or cost-effective process for upcycling waste cathode materials to adjust the transition metal content of waste cathode materials and to recover useable cathode materials therefrom, such as converting waste cathode materials with lower nickel content, such as LiNi_{0.33}Co_{0.33}Mn_{0.33}O₂ (NMC111), into useable higher nickel content materials, such as LiNi_{0.60}Co_{0.20}Mn_{0.20}O₂ (NMC622) and LiNi_{0.80}Co_{0.10}Mn_{0.10}O₂ (NMC811), e.g., to achieve the greater capacities required to meet modern energy storage needs.

The methods described herein address these ongoing needs.

### SUMMARY OF THE INVENTION

A method for adjusting the transition metal (TM) composition of lithium transition metal oxide (LiTMO) cathode active material, such as a lithium nickel manganese cobalt oxide material, is described herein. The method comprises precipitating a TM hydroxide onto the surface of particles of a first LiTMO to form coated particles; isolating the coated particles; combining the isolated coated particles with a selected amount of lithium hydroxide; and heating the resulting mixture at a temperature in the range of about 700 to about 950° C. (e.g., 800 to 900° C.) to form a second LiTMO that has a different transition metal composition than the first LiTMO. The amount of lithium hydroxide is selected to afford a target ratio of lithium to transition metals in the second LiTMO after calcining.

In some embodiments, the first LiTMO comprises a cathode active material recovered from waste lithium battery cathodes (e.g., cathode active materials of general formula LiₙMO₂ wherein 0<n≤1, and M comprises one or more transition metal ions, e.g., one or more transition metal ions selected from the group consisting of Ni, Mn, and Co ions). Preferably, the slurry of the first LiTMO is formed with a waste solution from a cathode manufacturing process, which comprises transition metal and other ions (e.g., Ni, Mn, Co, ammonium, hydroxide, and sulfate ions, among others). The slurry of the first LiTMO typically has a basic pH, e.g., a pH greater than 10, 11, or 12. A TM salt solution (e.g., a transition metal sulfate solution) is added to the slurry at a controlled rate and a TM hydroxide precipitates to form a coating around particles of the first LiTMO in the slurry. Optionally, an aqueous solution of one or more base, such as sodium hydroxide, ammonium hydroxide, or a combination thereof, is added at a controlled rate at the same time as the TM salt, which typically increases the amount of the TM hydroxide coating that forms around the LiTMO particles. During this process the pH of the solution drops, which makes the inside of the particles have the highest pH in the slurry. This results in a deeper penetration of the coating as compared to traditional methods of precipitation at constant pH. If desired, metal ions other than transition metals (e.g., Al, Ga, or Mg), can be also incorporated into the cathode materials, e.g., to adjust the electrochemical properties and/or stability of the resulting second LiTMO.

The TM salt solution and any additional base solution are added until a desired amount of transition metal hydroxide has precipitated and coated the particles of the first LiTMO. Typically, the coated particles are analyzed to determine the stoichiometry of the different transition metal ions in the coated particles. Optionally the precipitation is repeated one or more times on the already coated particles until a desired transition metal stoichiometry is achieved. The coated particles are then isolated, and preferably, the isolated coated particles are washed (e.g., with water) and dried. The coated particles are analyzed to determine the lithium and transition metal compositional stoichiometry thereof, and then the recovered coated particles are combined with an amount of lithium hydroxide sufficient to achieve a target stoichiometry of lithium to transition metals (e.g., 1:1 Li:M for a targeted LiTMO of formula LiM′O₂, wherein M′ comprises the same transition metal ions in the same relative amounts as the TMs of the first LiTMO plus the TMs of the coating). The resulting mixture is then calcined at a temperature of at least about 500° C., preferably a temperature in the range of about 700 to about 950° C., more preferably 800 to about 900° C. to obtain a second LiTMO with the target stoichiometry of lithium and transition metals.

In some embodiments, the first LiTMO is a material of general formula LiₙMO₂ wherein 0<n≤1, and M comprises one or more metal ions selected from the group consisting of Ni, Mn, and Co ions. When M comprises a single transition metal, the transition metal salt and the precipitated transition metal hydroxide comprise at least one transition metal that is different from M. When M comprises two or more transition metals, the TM salt and precipitated TM hydroxide can comprise one or more of the same transition metals as M, or a different TM, or both.

In one embodiment, the first LiTMO is a material of general formula LiₙMO₂ wherein 0<n≤1, and M comprises Ni, Mn, and Co ions (referred to as an NMC). The TM salt can comprise any desired transition metal. In some embodiments, the TM salt comprises a Ni salt (e.g., nickel sulfate), a manganese salt (e.g., manganese sulfate), a cobalt salt (e.g., cobalt sulfate) or a combination of two or more of the foregoing. Typically, when starting with an NMC as the first LiTMO, the TM salt will be a nickel salt, in order to increase the nickel content of the first LiTMO.

The following non-limiting embodiments are provided to illustrate certain aspects and features of the methods described herein.

Embodiment 1 is a method for adjusting the transition metal content of a lithium transition metal oxide (LiTMO) cathode material recovered from waste lithium battery cathodes comprising the steps of:
(a) precipitating a transition metal hydroxide onto the surface of particles of a first LiTMO to form coated particles, wherein the transition metal hydroxide comprises one or more transition metals;
(b) isolating the coated particles;
(c) combining the coated particles isolated in step (b) with a selected amount of lithium hydroxide to form a precursor mixture;
(d) calcining the precursor mixture at a temperature of at least about 500° C. (e.g., about 700 to about 950° C.) for a period of time sufficient to allow the transition metals of the transition metal hydroxide coating to substantially uniformly diffuse into the interior of the particles of the first LiTMO and for lithium from the lithium hydroxide to combine with the lithium of the first LiTMO to form a second LiTMO that is different from the first LiTMO; and
(e) isolating the second LiTMO;
wherein the first LiTMO comprises one or more transition metals; and the transition metal hydroxide is selected such that (1) the number of different transition metals in the second LiTMO differs from the number of different transition metals in the first LiTMO; (2) the molar proportions of different transition metals in the second LiTMO differ from the molar proportions of different transition metals in the first LiTMO; or (3) both (1) and (2).

Embodiment 2 is the method of embodiment 1, wherein the transition metal content of the second LiTMO is at least 10 mol % greater than the transition metal composition of the first LiTMO.

Embodiment 3 is the method of embodiment 1 or 2, wherein the first LiTMO is a material of formula LiₙMO₂, wherein 0<n≤1, and M comprises at least one transition metal; the amount of lithium hydroxide in the precursor mixture is sufficient to bring n equal to 1 after calcining; and the second LiTMO is a material of formula LiM′O₂, wherein M′ comprises the transition metals present in M plus the transition metals of the transition metal hydroxide; and the coated particles are calcined at about 700 to about 950° C.

Embodiment 4 is the method of embodiment 3, wherein the transition metal hydroxide comprises at least one transition metal that is the same as a transition metal of M.

Embodiment 5 is the method of embodiment 3 or 4, wherein M comprises one or more transition metal selected from the group consisting of Ni, Mn, and Co.

Embodiment 6 is the method of embodiment 5, wherein the transition metal hydroxide is selected from the group consisting of nickel hydroxide, manganese hydroxide, cobalt hydroxide, and a combination of two or more of the foregoing hydroxides.

Embodiment 7 is the method of embodiment 3, wherein M comprises a single transition metal; and the transition metal hydroxide comprises at least one transition metal that is different from the transition metal of M.

Embodiment 8 is method of embodiment 7, wherein the single transition metal of Mis selected from the group consisting of Ni, Mn, and Co.

Embodiment 9 is the method of embodiment 8, wherein the transition metal hydroxide is selected from the group consisting of nickel hydroxide, manganese hydroxide, cobalt hydroxide, and a combination of two or more of the foregoing hydroxides.

Embodiment 10 is the method of any one of embodiments 1 through 9, wherein the precipitating in step (a) is performed by adding a solution of a transition metal salt to an aqueous slurry of the first lithium transition metal oxide at a basic pH.

Embodiment 11 is the method of embodiment 10, wherein the aqueous slurry comprises particles of the first lithium transition metal oxide suspended in an aqueous cathode manufacturing waste stream.

Embodiment 12 is the method of embodiment 10 or 11, wherein an aqueous base is added to the slurry at the same time the transition metal salt is added.

Embodiment 13 is the method of embodiment 12, wherein the aqueous base comprises an alkali metal hydroxide, ammonium hydroxide, or a combination thereof.

Embodiment 14 is the method of any one of embodiments 1 through 13, wherein step (d) is performed at a temperature in the range of about 800 to about 900° C.

Embodiment 15 is the method of any one of embodiments 1 through 13, wherein an additional heating step is performed between step (b) and step (c) to convert the transition metal hydroxide to a transition metal oxide at a temperature in the range of about 800 to about 900° C. before proceeding with step (d).

Embodiment 16 is the method of any one of embodiments 1 through 15, further comprising analyzing the coated particles isolated in step (b) to determine a molar ratio of different transition metals in the coated particles; and repeating step (a), if needed, until the molar ratio of different transition metals in the coated particles reaches a preselected target molar ratio of transition metal ions.

Embodiment 17 is the method of any one of embodiments 1 through 16, further comprising analyzing the coated particles to determine the lithium content thereof and selecting the amount of lithium hydroxide in the precursor mixture so as to afford a target molar ratio of lithium to transition metals after calcining.

Embodiment 18 is a method for adjusting the transition metal content of a lithium nickel manganese cobalt oxide (NMC) cathode material; the method comprising the steps of:
(a) adding a solution of a transition metal salt to a slurry of a first NMC dispersed in an aqueous solvent at a basic pH, wherein the first NMC is a material of formula LiₙNiₓMn_{y}Co_{z}O₂, recovered from waste lithium battery cathodes; wherein 0<n≤1, 0<x<1, 0<y<1, 0<z<1, and x+y+z=1; thereby precipitating a transition metal hydroxide onto the surface of particles of the first NMC to form coated particles;
(b) isolating the coated particles;
(c) analyzing the coated particles to determine a molar ratio of Ni:Mn:Co in the coated particles; and repeating steps (a) and (b), if needed, until the molar ratio of Ni:Mn:Co in the coated particles reaches a preselected target molar ratio of Ni:Mn:Co;
(d) analyzing the coated particles having the preselected target molar ratio of Ni:Mn:Co to determine the lithium content thereof;
(e) combining the coated particles analyzed in step (d) with a preselected amount of lithium hydroxide to form a precursor mixture; wherein preselected amount of the lithium hydroxide is sufficient to afford a molar content of lithium in the precursor mixture at least equal to a combined molar content of the Ni, Mn, and Co in the precursor mixture;
(f) calcining the precursor mixture at a temperature in the range of about 800 to about 900° C. for a time sufficient for the transition metals of the coating to substantially uniformly diffuse into the particles and for lithium from the lithium hydroxide to combine with the lithium of the first NMC to form a modified NMC that comprises the preselected target molar ratio of Ni:Mn:Co and a molar lithium content about equal to the combined Ni, Mn, and Co content of the modified NMC; and
(g) isolating the modified NMC;
wherein the transition metal salt is selected from the group consisting of a nickel salt, a manganese salt, a cobalt salt, and a combination of two or more of the foregoing; and the preselected target molar ratio of Ni:Mn:Co is different from the molar ratio of Ni:Mn:Co in the first NMC.

Embodiment 19 is the method of embodiment 18, wherein the transition metal salt is selected from the group consisting of nickel sulfate, manganese sulfate, cobalt sulfate, and a combination of two or more of the foregoing sulfates.

Embodiment 20 is the method of embodiment 18 or 19, wherein the aqueous slurry comprises particles of the first NMC suspended in an aqueous cathode manufacturing waste stream comprising less than about 5000 ppm of Ni and less than 10 ppm of other transition metals that will precipitate as a metal hydroxide at a basic pH.

Embodiment 21 is the method of any one of embodiments 18 through 20, wherein an aqueous base is added to the slurry in step (a) at the same time the transition metal salt is added.

Embodiment 22 is the method of embodiment 21, wherein the aqueous base comprises an alkali metal hydroxide, ammonium hydroxide, or a combination thereof.

Embodiment 23 is the method of any one of embodiments 18 through 22, wherein the first NMC is a material of formula LiₙNi_{1/3}Mn_{1/3}Co_{1/3}O₂, wherein 0<n≤1, the transition metal salt is a nickel salt, and the modified NMC is a material of formula LiNiₓMn_{y}Co_{z}O₂, wherein x+y+z=1; y=z; and either

$$0.40 \leq x \leq 0.9 , 0.05 \leq y \leq 0.30 , 0.05 \leq z \leq 0.3 ; or \qquad ( i )$$

$$0.5 \leq x \leq 0.9 , 0.05 \leq y \leq 0.25 , and 0.05 \leq z \leq 0.25 ; or \qquad ( ii )$$

$$0.6 \leq x \leq 0.8 , 0.1 \leq y \leq 0.2 , and 0.1 \leq z \leq 0.20 . \qquad ( iii )$$

Embodiment 24 is a method for adjusting the transition metal content of a lithium transition metal oxide (LiTMO) cathode material recovered from waste lithium battery cathodes comprising the steps of:
(a) precipitating a transition metal hydroxide onto the surface of particles of a first LiTMO to form coated particles, wherein the transition metal hydroxide comprises one or more transition metals;
(b) isolating the coated particles;
(c) calcining the coated particles at a temperature in the range of about 700 to about 950° C. for a period of time sufficient to allow the transition metals of the transition metal hydroxide coating to substantially uniformly diffuse into the interior of the particles of the first LiTMO to form an intermediate LiTMO that is different from the first LiTMO;
(d) isolating the intermediate LiTMO;
(e) combining the intermediate LiTMO isolated in step (d) with a selected amount of lithium hydroxide to form a mixture;
(f) calcining the mixture created in step (e) at a temperature in the range of about 700 to about 950° C. for a period of time sufficient for lithium from the lithium hydroxide to combine with the lithium of the intermediate LiTMO to form a second LiTMO that is different from the first LiTMO and the intermediate LiTMO;
(g) isolating the second LiTMO;
wherein the first LiTMO comprises one or more transition metals; and the transition metal hydroxide is selected such that (1) the number of different transition metals in the second LiTMO differs from the number of different transition metals in the first LiTMO; (2) the molar proportions of different transition metals in the second LiTMO differ from the molar proportions of different transition metals in the first LiTMO; or (3) both (1) and (2).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 provides a flow diagram of a method for adjusting the transition metal composition of a lithium transition metal oxide material.

FIG. 2 provides cross-sectional scanning electron microscopy/energy dispersive X-ray spectroscopy (SEM/EDS) images of a commercial Li_{1.06}Ni_{0.33}Mn_{0.33}Co_{0.33}O₂ particle (NMC111; left), a particle of Li_{1.06}Ni_{0.33}Mn_{0.33}Co_{0.33}O₂ coated with Ni(OH)₂ (middle); and a particle of LiNi_{0.65}Mn_{0.18}Co_{0.18}O₂ formed after calcining the Ni(OH)₂-coated Li_{1.06}Ni_{0.33}Mn_{0.33}Co_{0.33}O₂ at greater than 800° C., according to the methods described herein.

FIG. 3 illustrates X-ray powder diffraction (XRD) spectra for samples of NMC622 prepared from NMC111 at various temperatures following the methods described herein.

FIG. 4 illustrates particle diameter versus temperature of relithiation (calcining temperature) for NMC622 prepared from commercial NMC111 at different temperatures following the methods described herein, compared to a commercial sample of NMC111.

FIG. 5 provides plots of specific discharge capacity versus cycle number for samples of NMC622 prepared from NMC111 at different calcining temperatures following the methods described herein, compared to a commercial NMC111 sample.

### DETAILED DESCRIPTION

LiTMO cathode materials are particulate materials typically having an average particle size of about 5 to about 20 μm as determined, e.g., by sieving with standard particle sizing sieves. When used as cathode active materials in lithium batteries, the particles of the LiTMO are dispersed in a binder composition, typically along with a particulate carbon materials, and are coated onto a current collector, such as aluminum foil, to form the cathode of the battery. When lithium batteries are no longer able to perform adequately, the batteries are discarded. Because battery components include many expensive and difficult to obtain substances, there is a growing movement to recycle and/or recover and reuse many battery components, such as the cathode active materials in the batteries, especially in applications that use large lithium batteries, such as hybrid and electric vehicles. Such recycling can take the form of recovering the transition metals present in the materials, e.g., as purified metals; however, it can be more economical and environmentally friendly to if the cathode materials can be recovered and reused without reducing the transition metals back to their elemental forms. One problem with this approach is that the cathode materials used in lithium batteries change over time and differ depending on the applications in which they are used. The ability to convert or upgrade older technology cathode materials to newer, more efficient materials would greatly enhance battery recycling options. In many cases, newer technology LiTMO cathode materials have similar structures to those which are no longer used, but with different transition metal compositions and stoichiometries.

As described herein, a method for adjusting or “upcycling” the transition metal composition of a LiTMO cathode active material, such as an NMC cathode material, comprises precipitating a transition metal hydroxide onto the surface of particles of a first LiTMO to form coated particles; isolating the coated particles; combining the isolated coated particles with a selected amount of lithium hydroxide; and calcining the resulting mixture at a temperature of at least about 500° C., and preferably in the range of about 700 to about 950° C. to form a second lithium transition metal oxide that has a different transition metal composition than the first lithium transition metal oxide material; wherein the amount of the TM coating on the particles and the amount of lithium hydroxide in the precursor mixture is selected to afford a target ratio of lithium to transition metals and a target ration of TM ions in the second lithium transition metal oxide after calcining.

As used herein in the context of a method of adjusting the TM content of a LiTMO, the term “calcining” refers to a process of heating the precursor mixture of lithium hydroxide and the TM hydroxide coated particles of the first LiTMO in air at a temperature and for a period of time sufficient for TM ions from the TM hydroxide coating to migrate into the interior of the LiTMO particles, while concurrently oxidizing the TM hydroxide to a TM oxide and incorporating lithium from the lithium hydroxide, thereby affording a second LiTMO with a different composition than the first LiTMO. Volatile byproducts (e.g., water) and/or volatile contaminants are also removed by calcination. Since some LiOH can volatilize at typical calcination temperatures, the calcining step is typically carried out with a slight excess of LiOH (e.g., about 2 to 6 mol percent (mol %) excess) to achieve the desired amount of lithium in the second LiTMO. The calcining temperature preferably is greater than 750° C., more preferably about 800 to about 900° C. (e.g., about 850° C.)

In some embodiments, the first LiTMO is a material of general formula LiₙMO₂, wherein 0<n≤1.1 (typically 0<n≤1), and M comprises one or more transition metals; and the second LiTMO is a material of formula LiM′O₂ when M′ comprises the same TMs as M plus the TMs of the TM salt. When M comprises a combination of Ni, Mn, and Co ions, the material is referred to as an NMC (referred to as an NMC). In some embodiments, when starting with an NMC as the first LiTMO, the TM salt will be a nickel salt, in order to increase the nickel content of the first LiTMO. In some embodiments, the first LiTMO is an NMC of formula LiₙNiₓMn_{y}Co_{z}O₂, recovered from waste lithium battery cathodes; wherein 0<n≤1, 0<x<1, 0<y<1, 0<z<1, and x+y+z=1. For example, the first LiTMO can be a material of formula LiₙNi_{1/3}Mn_{1/3}Co_{1/3}O₂, wherein 0<n≤1, which is a commonly used cathode material in older hybrid and electric vehicle batteries, and the transition metal salt is a nickel salt, such that the method results in a modified NMC of formula LiNiₓMn_{y}CO_{z}O₂, wherein 0.40≤x≤0.9, 0.05≤y≤0.30, 0.05≤z≤0.30, y=z, and x+y+z=1 (e.g., 0.50≤x≤0.9, 0.05≤y≤0.25, and 0.05≤z≤0.25; or 0.60≤x≤0.8, 0.1≤y≤0.20, and 0.1≤z≤0.20).

The TM salt can comprise any desired transition metal needed to transform the first LiTMO into the target upcycled second LiTMO. In some embodiments, the TM salt comprises a Ni salt (e.g., nickel sulfate), a manganese salt (e.g., manganese sulfate), a cobalt salt (e.g., cobalt sulfate) or a combination of two or more of the foregoing. If desired, minor amounts (e.g., less than about 10 mole percent) of metal ions other than transition metals (e.g., Al, Ga, or Mg), can be also incorporated into the cathode materials, e.g., to adjust the electrochemical properties and/or stability of the resulting second LiTMO.

In some embodiments, the precipitation of the TM hydroxide is accomplished by forming an aqueous slurry of the first LiTMO, which will typically have a basic pH, and then adding an aqueous solution of a TM salt to the slurry. At basic pH, TMs from the salt precipitate as TM hydroxides onto the surface of the LiTMO particles in the slurry, forming a coating around the particles. Precipitation of the TM hydroxide can be further facilitated by adding an aqueous base at the same time the TM salt solution is added. The base will typically be an alkali metal hydroxide (e.g., sodium hydroxide or potassium hydroxide), ammonium hydroxide (i.e., aqueous ammonia), or a combination of an alkali metal hydroxide and aqueous ammonia. Simultaneous addition of an aqueous base generally increases the amount of TM hydroxide that will precipitate onto the LiTMO in the slurry, thus enhancing the amount of additional TM that can be incorporated into the upcycled second LiTMO. The counter ions for the TM salts can be any counter ion that affords a water soluble TM salt, such as, e.g., sulfate, halide (e.g., chloride or bromide), nitrate, acetate, and the like.

The coated particles can be isolated by any convenient method for isolating solid particles, e.g., by decanting away the supernatant, centrifugation, filtration, and the like, which are well known in the chemical art. Preferably, the isolated coated particles are washed to remove soluble impurities, and then dried before further processing. Typically, the coated particles are analyzed to verify the elemental composition of the material, particularly to identify the different transition metals and quantify the relative molar ratio of the transition metals in the coated particles. If the measured ratio of transition metals in the coated particles does not match the molar ratio of transition metals in the target composition (i.e., the ratio in the targeted second LiTMO), the precipitation and isolation steps can be repeated until the desired ratio is obtained. In some embodiments, an initial annealing step is performed between 800 to about 900° C. to convert the TM hydroxide coating into TM oxide before calcination, which can improve the discharge capacity of the second LiTMO compared to the same composition made without the additional annealing step. The isolated particles are also analyzed to determine the lithium content of the coated particles, and then the coated particles are combined with a sufficient amount of lithium hydroxide to form a precursor mixture having a molar lithium content equal to the lithium content of the targeted second LiTMO. In the case of a target LiTMO of formula LiM′O₂, where M′ comprises two or more TMs (i.e., two or more transition metal ions) the desired ratio of Li to TMs is 1:1. Typically, a slight excess of lithium hydroxide is used (e.g., 2 to 6 mol % excess) since some lithium often volatilizes under calcining conditions. Any analytical method for determining elemental composition can be used to analyze the product (e.g., EDS).

The precursor mixture is then heated at a temperature of about 700 to about 950° C. to induce migration of the TMs from the coating into the interior of the particles and to oxidize the added TMs so that they integrate into the LiTMO structure, as well as to incorporate the lithium from the lithium hydroxide into the structure of the LiTMO. Preferably, the conditions are such that the transition metals substantially uniformly distribute throughout the particles. As used herein, the phrase “substantially uniformly distribute” and grammatical variations thereof, as applied to transition metal ions from the coating of the coated particles described herein, means that after diffusing into the particles, the concentration of the transition metal ions from the coating varies by not for than about 10%, e.g., not more than about 5%, or not more than about 3%, throughout the particles. The distribution of transition metal ions in LiTMO particles can be assessed by a variety of methods that are well-known in the chemical arts. For example, scanning electron microscopy combined with energy-dispersive X-ray spectroscopy (SEM-EDS) and elemental-specific tomographic transmission X-ray microscopy (TXM) can be used to determine the elemental distribution of TM ions in metal oxide particles.

In some embodiments, the supernatant of the slurry is a waste byproduct from a cathode manufacturing process using coprecipitation of metal hydroxides. Such waste byproduct supernatants generally comprise a solution of ions, including sodium, sulfate, ammonium, hydroxide, and unprecipitated metal ions of cobalt, manganese, and/or nickel. The types and concentrations of transition metal ions in supernatant are dependent on the particular cathode composition being made by the process. Typically, the concentrations of TMs and other ions that can precipitate at basic pH in the supernatant, prior to making the slurry, are less than about 5000 ppm of Ni and less than 10 ppm of other TM ions, e.g., less than about 1000 ppm, and thus do not significantly contaminate or interfere with the process. Using a cathode manufacturing waste steam as the supernatant can reduce the cost and environmental impact of the upcycling process.

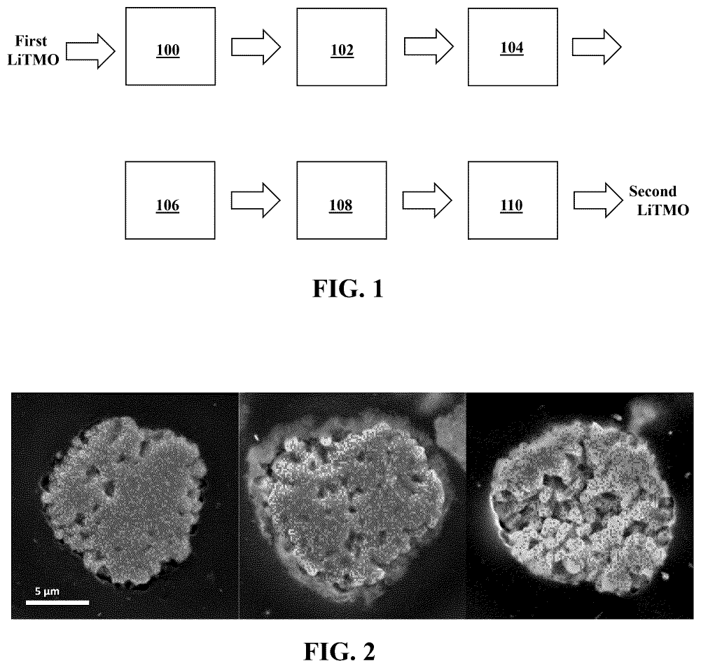

FIG. 1 provides a flow diagram for one embodiment of a method described herein. In FIG. 1, the method comprises Step 100: forming a slurry of a first LiTMO in an aqueous supernatant; Step 102: adding an aqueous solution of a TM salt to the slurry to thereby precipitate a TM hydroxide as a coating on particles of the first LiTMO in the slurry; Step 104: optionally adding an aqueous base to the slurry at the same time as the TM salt; Step 106 isolating and analyzing the resulting coated particles to determine the TM content and the lithium content of the particles, and optionally repeating steps 102 to 106 until the coated particles have a preselected target TM content and stoichiometry; Step 108: forming a precursor composition by combining the isolated coated particles from Step 106 with an amount of lithium hydroxide sufficient to achieve a lithium-to-TM ratio of a target LiTMO having the target TM content and stoichiometry; and Step 110: calcining the precursor mixture at a temperature of about 700 to 950° C. and for a period of time sufficient form the target LiTMO.

The following non-limiting examples are provided to illustrate certain aspects and features of the methods, electrodes, cells and batteries described herein.

### Example 1. Preparation of Modified Lithium Transition Metal Oxide Materials—General Procedure

### Precipitation.

A slurry of a LiTMO, e.g., a LiTMO recovered from waste batteries, is prepared by adding the LiTMO powder to an aqueous supernatant at a concentration of about 20 to about 100 grams (g) of LiTMO per liter of supernatant (e.g., about 50 g/L). The supernatant comprises water and optionally is an aqueous waste stream from a lithium battery cathode manufacturing process. Next, a selected amount of the slurry is added to a reactor (e.g., a jacketed tank reactor). The starting pH of the cathode slurry typically is about 11 to 12. Optionally the pH of the slurry can be adjusted to obtain a pH of about 11 to 12. Optionally, the temperature of the slurry in the reactor is brought to a temperature of about 50° C. under constant stirring (800-1200 rpm) under a nitrogen atmosphere (e.g., a flow of nitrogen gas. An aqueous solution of a transition metal salt (e.g., a transition metal sulfate) is continuously added to the slurry to precipitate the transition metal of the transition metal salt as a TM hydroxide onto the surface of the LiTMO particles. Precipitation of a sufficient amount of Ni hydroxide to convert Li_{1.0}Ni_{0.33}Co_{0.33}Mn_{0.33}O₂ to Li_{1.0}Ni_{0.48}Co_{0.26}Mn_{0.26}O₂ can be accomplished simply by adding a Ni salt solution to a basic slurry of the Li_{1.0}Ni_{0.33}Co_{0.33}Mn_{0.33}O₂.

If a higher level of TM incorporation is desired, typically, an aqueous solution of a base such as sodium hydroxide, ammonium hydroxide or a combination of sodium hydroxide and ammonium hydroxide is added to the slurry at the same time as the TM salt solution to enhance the precipitation of the TM hydroxide on the particle surfaces. Addition of ammonium hydroxide results in more conformal coatings and facilitates higher deposition of larger amounts of TM salts, and thus affords higher levels of added TM in the final calcined products. The aqueous base typically is added at a molar deficit compared to the amount of TM salt needed to fully form a desired amount of the precipitate on the surface of the particles. The deficit of base causes the pH to slowly drop over time as hydroxide ions are scavenged from the supernatant solution. The addition rates of the TM salt and base solutions can be varied to optimize the TM hydroxide coating for a given target LiTMO.

Other concentrations of the starting reactants can be used as long as the molar ratio of sodium hydroxide to the TM sulfate is less than about 2:1 to create a hydroxide deficit and a gradual drop in pH during the precipitation. Higher concentrations of the reactants generally are better due to the reduced water use.

Typically, the precipitation is complete when a pH of about 8.9 to 9.0 is reached. Typically, the slurry is allowed to stir for 30 min before draining the reactor, allowing the coated particles to settle, and then decanting the supernatant. The coated particles typically are washed with DI water after the supernatant has been removed. This procedure typically is repeated three times or more to reach a conductivity of the wash water of about 30 μS/cm. The final washed product is then filtered, dried, and sieved, e.g., to 45 microns, to deagglomerate the particles of TM hydroxide-coated LiTMO.

### High-Temperature Relithiation:

Due to lithium loss both from previous degradation from cycling in end-of-life cathode material and leaching during the coating reaction, additional lithium is added to target a final molar ratio of 1.05Li:1.0TM for a LiTMO having a 1:1 stoichiometry of Li to TM, and the resulting precursor mixture is heated to a temperature above 700° C. This high-temperature step (also referred to as calcination) also promotes the TM diffusion from the surface of the particles to the bulk interior of the particles, and evens out added TM content across the secondary particles.

A typical heating profile under 200 L/h flow of air is as follows: From room temperature, the furnace is heated at a rate of 5° C./min to 500° C., then held at 500° C. for 6 hours before heating to 900° C. at a rate of 5° C./min, then held at 900° C. for 6 hours before cooling to room temperature at a rate of 5° C./min. By varying the upper cutoff temperature from 700° C. to 950° C., the extent of added TM diffusion can be controlled in both the secondary and primary particles.

### Example 2. Preparation and Characterization of NMC622 and NMC811

A slurry of a commercial NMC111 from Toda (Li_{1.06}Ni_{0.33}Mn_{0.33}Ni_{0.33}O₂) was prepared by adding the NMC111 powder to an aqueous supernatant at a concentration of about 50 g of NMC111 per liter of supernatant, and was allowed to stand overnight. Next, 2 L of the slurry was added to a 4 L jacketed tank reactor. The starting pH of the cathode slurry was about 11.9. The temperature of the slurry in the reactor was brought to about 50° C. under constant stirring (800-1200 rpm) and a nitrogen flow of 5 standard cubic feet per hour (scfh). In this example, the supernatant was a cathode manufacturing solution comprising the composition shown in Table 1, along with the composition of the supernatant after forming the slurry and after addition of the nickel sulfate.

TABLE 1
Supernatant compositions as measured by ICP-OES.

| | | Co | Li | Mn | Na | Ni | S |
|---|---|---|---|---|---|---|---|
| Sample | | ppm | ppm | ppm | ppm | ppm | ppm |
| Initial Supernatant | | 0 | 0 | 0 | 38100 | 563 | 25900 |
| Supernatant with | | 0 | 30.1 | 0 | 37900 | 568 | 24800 |
| Cathode Added | | | | | | | |
| Supernatant | Ave. | 1.08 × 10⁻⁵ | 3.70 × 10⁻³ | 0 | 3.09 | 4.13 × 10⁻¹ | 2.77 |
| After Reaction* | STD | 4.55 × 10⁻⁶ | 9.65 × 10⁻⁴ | 0 | 7.19 × 10⁻¹ | 4.22 × 10⁻² | 6.03 × 10⁻¹ |

*Average from four reactions

A 2 M nickel sulfate solution was added to the slurry at a rate of about 6 mL/min, simultaneously with a 4 M sodium hydroxide solution at a rate of 3 mL/min.

The sodium hydroxide was added at a molar deficit of about one fourth compared to the nickel sulfate according to the amount needed to fully form a Ni(OH)₂ precipitate deposited on the surface of the NMC111 particles in the slurry. The deficit of base caused the pH to slowly drop over time as hydroxide ions are scavenged from the supernatant solution. Additionally, some Ni from the supernatant is consumed.

The reaction was complete when a pH of about 8.9 to 9.0 was reached. For a conversion from NMC111 to NMC622, the amount of nickel sulfate added to reach the final pH was about 0.5 L. The slurry is allowed to stir for 30 min before draining the reactor through a bottom port. To obtain NMC811, a sample of NMC622 was used as the first LiTMO in the process as described above for conversion of NMC111 to NMC622. In addition, aqueous ammonium hydroxide can be added along with the sodium hydroxide, to promote a greater quantity of nickel hydroxide to precipitate and coat the NMC particles so as to obtain a higher Ni content in the coated particles and subsequently calcined products than can be achieved with sodium hydroxide alone.

The Ni(OH)₂-coated NMC111 was allowed to settle, the supernatant was decanted, and DI water was added with stirring, to wash the coated particles. This washing procedure was repeated three times or more to reach a conductivity of the wash water of about 30 μS/cm. The final washed coated NMC111 was then filtered, dried, and sieved to 45 microns to deagglomerate the particles of Ni(OH)₂-coated NMC111.

Lithium hydroxide was added to the isolated Ni(OH)₂-coated NMC111 to obtain a target a final molar ratio of 1.05Li:1.0TM, and samples of the resulting precursor mixture were calcined at temperatures of 750° C. and higher for a period of time sufficient to obtain a modified NMC incorporation the additional nickel. Multiple samples were calcined at different temperatures between 750 to 950° C. and the resulting modified NMC was analyzed by SEM/EDS to evaluate the extent of penetration of the added Ni into the interiors of the NMC particles. Temperatures of about 850° C. to about 950° C. appeared to be optimal for forming NMC622 with a relatively even distribution of the added Ni throughout the particles of the products. One sample (referred to as “UPC-Annealed”) had an additional annealing step at 800° C. for 10 hr before the addition of LiOH and calcination at 900° C. The annealing step effectively converts the Ni(OH)₂ coating into NIO while densifying the coating and initiating Ni diffusion before calcination to convert to LiTMO₂.

FIG. 2 provides cross-sectional scanning electron microscopy/energy dispersive X-ray spectroscopy (SEM/EDS) images of a commercial Li_{1.06}Ni_{0.33}Mn_{0.33}Co_{0.33}O₂ particle (NMC111; left), a particle of Li_{1.06}Ni_{0.33}Mn_{0.33}Co_{0.33}O₂ coated with Ni(OH)₂ (middle); and a particle of LiNi_{0.65}Mn_{0.18}Co_{0.18}O₂ formed after calcining the Ni(OH)₂-coated Li_{1.06}Ni_{0.33}Mn_{0.33}Co_{0.33}O₂ at greater than 800° C., according to the methods described herein. Ni is shown in green, Mn in red and Co in blue. As can be seen in the image on the right, the Ni from the coating diffused evenly throughout the particle.

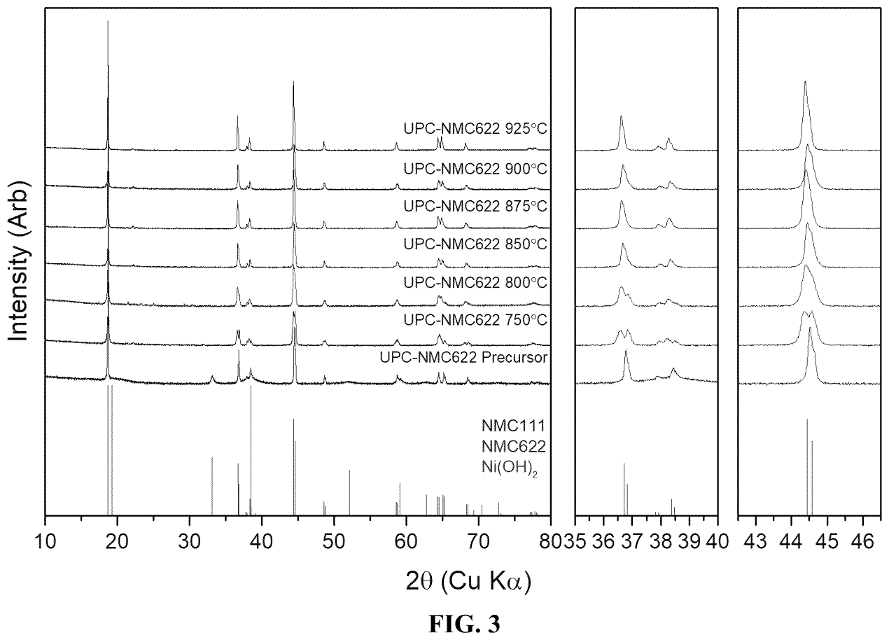

FIG. 3 illustrates X-ray powder diffraction (XRD) spectra for samples of NMC622 prepared from NMC111 at different calcining temperatures, as described above. As shown in FIG. 3, as calcination temperature increased from 750° C. to 925° C., the pXRD peaks combine and shift to lower 2θ, which is indicative of conversion to NMC622.

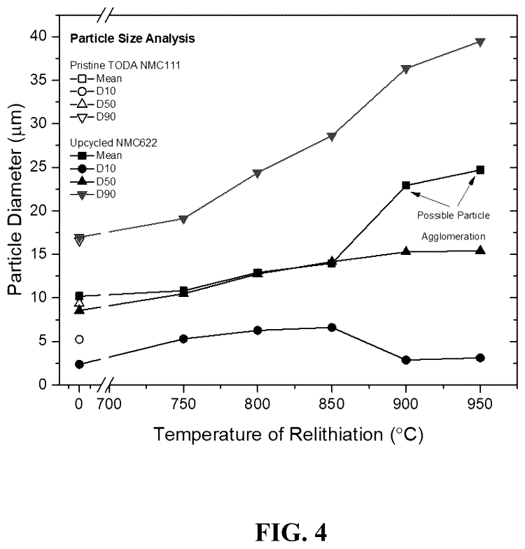

FIG. 4 illustrates particle diameter versus temperature of relithiation (calcining temperature) for NMC622 prepared from commercial NMC111 at different temperatures following the methods described herein, compared to a commercial sample of NMC111. The distribution of particle diameters is defined as follows: D10 is the lower 10%, D50 is 50%, and D90 is the upper 10% of the sampled material.

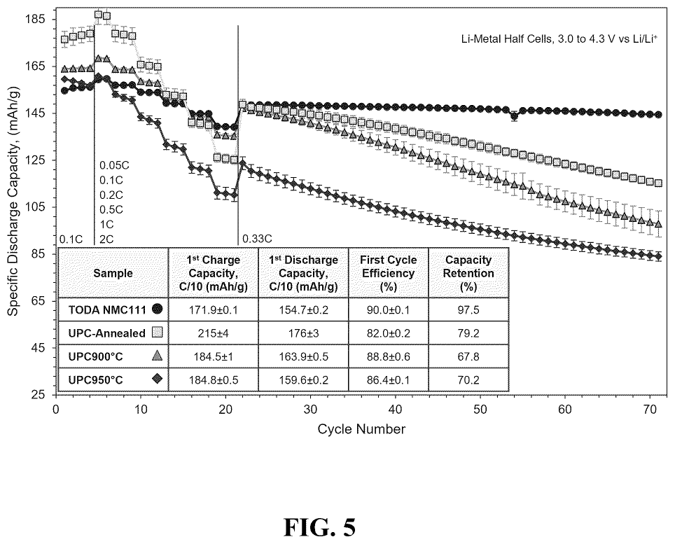

Samples of NMC622 prepared from commercial NMC111 by the above described method were electrochemically evaluated lithium half cells cycling between 3.0 and 4.3 V vs. Li/Li⁺ with four formation cycles at a rate of C/10, followed by a rate capability test of three cycles at increasing rates of C/20, C/10, C/5, C/2, 1C, and 2C, and ending in a cycle life test of 50 cycles at C/3. The average and standard deviation was taken from the performance of three cells with electrode loading of about 8 mg/cm² and a deviation of <0.06 mg/cm² between each set. FIG. 5 provides plots of specific discharge capacity versus cycle number for samples of NMC622 prepared from NMC111 at different calcining temperatures following the methods described herein, compared to a commercial NMC111 sample. The UPC-Annealed sample had an additional annealing step at 800° C. for 10 hrs followed by the calcination procedure identical to UPC-900° C. As shown in FIG. 5, an increase in initial discharge capacity during formation cycling at C/10 to 176±3 mAh/g was obtained through upcycling to NMC622 from the original NMC111 material at 154.7±0.2 mAh/g. All upcycled samples exhibited a reduced rate capability compared to the NMC111 material at rates >1C and a lower cycle life of 79.2% compared to 97.5% after 50 cycles at C/3.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The embodiments of the invention in which an exclusive property or privilege is claimed are defined as follows:

1. A method for adjusting the transition metal content of a lithium transition metal oxide (LiTMO) cathode material recovered from waste lithium battery cathodes comprising the steps of:
(a) precipitating a transition metal hydroxide onto the surface of particles of a first LiTMO to form coated particles, wherein the transition metal hydroxide comprises one or more transition metals;
(b) isolating the coated particles;
(c) combining the coated particles isolated in step (b) with a selected amount of lithium hydroxide to form a precursor mixture;
(d) calcining the precursor mixture at a temperature of at least about 500° C. for a period of time sufficient to allow the transition metals of the transition metal hydroxide coating to substantially uniformly diffuse into the interior of the particles of the first LiTMO and for lithium from the lithium hydroxide to combine with the lithium of the first LiTMO, to thereby form a second LiTMO that is different from the first LiTMO; and
(e) isolating the second LiTMO;
wherein the first LiTMO comprises one or more transition metals; and the transition metal hydroxide is selected such that (1) the number of different transition metals in the second LiTMO differs from the number of different transition metals in the first LiTMO; (2) the molar proportions of different transition metals in the second LiTMO differ from the molar proportions of different transition metals in the first LiTMO; or (3) both (1) and (2).

2. The method of claim 1, wherein the transition metal content of the second LiTMO is at least 10 mol % greater than the transition metal composition of the first LiTMO.

3. The method of claim 1, wherein the first LiTMO is a material of formula LiₙMO₂, wherein 0<n≤1, and M comprises at least one transition metal; the amount of lithium hydroxide in the precursor mixture is sufficient to bring n equal to 1 after calcining; and the second LiTMO is a material of formula LiM′O₂, wherein M′ comprises the transition metals present in M plus the transition metals of the transition metal hydroxide; and the coated particles are calcined at about 700 to about 950° C.

4. The method of claim 3, wherein the transition metal hydroxide comprises at least one transition metal that is the same as a transition metal of M.

5. The method of claim 3, wherein M comprises one or more transition metal selected from the group consisting of Ni, Mn, and Co.

6. The method of claim 5, wherein the transition metal hydroxide is selected from the group consisting of nickel hydroxide, manganese hydroxide, cobalt hydroxide, and a combination of two or more of the foregoing hydroxides.

7. The method of claim 3, wherein M comprises a single transition metal; and the transition metal hydroxide comprises at least one transition metal that is different from the transition metal of M.

8. The method of claim 7, wherein the single transition metal of M is selected from the group consisting of Ni, Mn, and Co.

9. The method of claim 8, wherein the transition metal hydroxide is selected from the group consisting of nickel hydroxide, manganese hydroxide, cobalt hydroxide, and a combination of two or more of the foregoing hydroxides.

10. The method of claim 1, wherein the precipitating in step (a) is performed by adding a solution of a transition metal salt to an aqueous slurry of the first lithium transition metal oxide at a basic pH.

11. The method of claim 10, wherein the aqueous slurry comprises particles of the first lithium transition metal oxide suspended in an aqueous cathode manufacturing waste stream.

12. The method of claim 10, wherein an aqueous base is added to the slurry at the same time the transition metal salt is added.

13. The method of claim 12, wherein the aqueous base comprises an alkali metal hydroxide, ammonium hydroxide, or a combination thereof.

14. The method of claim 1, wherein step (d) is performed at a temperature in the range of about 800 to about 900° C.

15. The method of claim 1, wherein an additional heating step is performed between step (b) and step (c) to convert the transition metal hydroxide to a transition metal oxide, at a temperature in the range of about 800 to about 900° C. before proceeding with step (d).

16. The method of claim 1, further comprising analyzing the coated particles isolated in step (b) to determine a molar ratio of different transition metals in the coated particles; and repeating step (a), if needed, until the molar ratio of molar ratio of different transition metals in the coated particles reaches a preselected target molar ratio of transition metal ions.

17. The method of claim 1, further comprising analyzing the coated particles to determine the lithium content thereof and selecting the amount of lithium hydroxide in the precursor mixture so as to afford a target molar ratio of lithium to transition metals after calcining.

18. A method for adjusting the transition metal content of a lithium nickel manganese cobalt oxide (NMC) cathode material; the method comprising the steps of:
(a) adding a solution of a transition metal salt to a slurry of a first NMC dispersed in an aqueous solvent at a basic pH, wherein the first NMC is a material of formula LiₙNiₓMn_{y}Co_{z}O₂, recovered from waste lithium battery cathodes; wherein 0<n<1, 0<x<1, 0<y<1, 0<z<1, and x+y+z=1; thereby precipitating a transition metal hydroxide onto the surface of particles of the first NMC to form coated particles;
(b) isolating the coated particles;
(c) analyzing the coated particles to determine a molar ratio of Ni:Mn:Co in the coated particles; and repeating steps (a) and (b), if needed, until the molar ratio of Ni:Mn:Co in the coated particles reaches a preselected target molar ratio of Ni:Mn:Co;
(d) analyzing the coated particles having the preselected target molar ratio of Ni:Mn:Co to determine the lithium content thereof;
(e) combining the coated particles analyzed in step (d) with a preselected amount of lithium hydroxide to form a precursor mixture; wherein preselected amount of the lithium hydroxide is sufficient to afford a molar content of lithium in the precursor mixture at least equal to a combined molar content of the Ni, Mn, and Co in the precursor mixture;
(f) calcining the precursor mixture at a temperature in the range of about 800 to about 900° C. for a time sufficient for the transition metals of the coating to substantially uniformly diffuse into the particles and for lithium from the lithium hydroxide to combine with the lithium of the first NMC to form a modified NMC that comprises the preselected target molar ratio of Ni:Mn:Co and a molar lithium content about equal to the combined Ni, Mn, and Co content of the modified NMC; and
(g) isolating the modified NMC;
wherein the transition metal salt is selected from the group consisting of a nickel salt, a manganese salt, a cobalt salt, and a combination of two or more of the foregoing; and the preselected target molar ratio of Ni:Mn:Co is different from the molar ratio of Ni:Mn:Co in the first NMC.

19. The method of claim 18, wherein the transition metal salt is selected from the group consisting of nickel sulfate, manganese sulfate, cobalt sulfate, and a combination of two or more of the foregoing sulfates.

20. The method of claim 18, wherein the aqueous slurry comprises particles of the first NMC suspended in an aqueous cathode manufacturing waste stream comprising less than about 5000 ppm of Ni and less than 10 ppm of other TM ions that will precipitate as a metal hydroxide at a basic pH.

21. The method of claim 19, wherein an aqueous base is added to the slurry in step (a) at the same time the transition metal salt is added.

22. The method of claim 20, wherein the aqueous base comprises an alkali metal hydroxide, ammonium hydroxide, or a combination thereof.

23. The method of claim 17, wherein the first LiTMO is a material of formula LiₙNi_{1/3}Mn_{1/3}Co_{1/3}O₂, wherein 0<n<1, the transition metal salt is a nickel salt, and the modified NMC is a material of formula LiNiₓMn_{y}Co_{z}O₂, wherein x+y+z=1; y=z; and either
$$0.4 \leq x \leq 0.9 , 0.05 \leq y \leq 0.30 , 0.05 \leq z \leq 0.3 ; or \qquad ( i )$$
$$0.5 \leq x \leq 0.9 , 0.05 \leq y \leq 0.25 , and 0.05 \leq z \leq 0.25 ; or \qquad ( ii )$$
$$0.6 \leq x \leq 0.8 , 0.1 \leq y \leq 0.2 , and 0.1 \leq z \leq 0.20 . \qquad ( iii )$$

24. A method for adjusting the transition metal content of a lithium transition metal oxide (LiTMO) cathode material recovered from waste lithium battery cathodes comprising the steps of:
(a) precipitating a transition metal hydroxide onto the surface of particles of a first LiTMO to form coated particles, wherein the transition metal hydroxide comprises one or more transition metals;
(b) isolating the coated particles;
(c) calcining the coated particles at a temperature in the range of about 700 to about 950° C. for a period of time sufficient to allow the transition metals of the transition metal hydroxide coating to substantially uniformly diffuse into the interior of the particles of the first LiTMO to form an intermediate LiTMO that is different from the first LiTMO;
(d) isolating the intermediate LiTMO;
(e) combining the intermediate LiTMO isolated in step (d) with a selected amount of lithium hydroxide to form a mixture;
(f) calcining the mixture created in step (e) at a temperature in the range of about 700 to about 950° C. for a period of time sufficient for lithium from the lithium hydroxide to combine with the lithium of the intermediate LiTMO to form a second LiTMO that is different from the first LiTMO and the intermediate LiTMO;
(g) isolating the second LiTMO;
wherein the first LiTMO comprises one or more transition metals; and the transition metal hydroxide is selected such that (1) the number of different transition metals in the second LiTMO differs from the number of different transition metals in the first LiTMO; (2) the molar proportions of different transition metals in the second LiTMO differ from the molar proportions of different transition metals in the first LiTMO; or (3) both (1) and (2).
